(19) United States
(12) Patent Application Publication
(10) Pub. No.: US 2016/0213554 A1
(43) Pub. Date: Jul. 28, 2016

(54) Massaging Device

(71) Applicants: Sean Possemato, Milford, MA (US); Paul Possemato, Milford, MA (US)

(72) Inventors: Sean Possemato, Milford, MA (US); Paul Possemato, Milford, MA (US)

(21) Appl. No.: 14/927,552

(22) Filed: Oct. 30, 2015

Related U.S. Application Data
(60) Provisional application No. 62/075,462, filed on Nov. 5, 2014.

(51) Int. Cl. A61H 15/00

(52) U.S. Cl. CPC A61H 15/0092; A61H 2015/0042

(57) ABSTRACT

A massaging device that has a handle with a shaft and a grip, a releasably coupled head that has a frame and an axle, a massaging element that is carried by the frame such that the massaging element can spin on the axle.

### CROSS-REFERENCE TO RELATED APPLICATIONS

This application claims benefit from U.S. Provisional Patent Application No. 62/075,462, filed Nov. 5, 2014, the contents of which are incorporated herein by reference.

### BACKGROUND

This disclosure relates to a device designed for personal massage. A variety of massage techniques are utilized in order to loosen or divide muscle tissue which is tight or has been strained or over-used. These techniques have provided relief and healing for countless people, yet they are very expensive and/or inconvenient for many would-be patients/clients. In an effort to provide a quality personal massage experience without the cost of services, there is a need for a device which will provide healing and relief for some of the muscular issues addressed by massage therapists.

### SUMMARY

Featured in this disclosure is a massaging device. In one aspect, a massaging device may include a handle and a head wherein the head may have an element and a frame with an axle on which the element may spin. The head may be releasably coupled to the handle, allowing the massaging device to be versatile with regard to its effectiveness on a variety of locations on the human body.

Embodiments may include one of the following features, or any combination thereof. The handle may be comprised of a shaft and a grip where the grip may be on the opposite end of the shaft as the releasably coupled head. The grip may be a generally circular knob or any other shape which may be gripped by a user who may grasp the massaging device anywhere along the length of the handle. The massaging device is particularly constructed and arranged such that a user may hold the device along the handle and press a massaging element against the body, at a desired position, angle and pressure, and using a desired motion. The massaging device thus allows a person to perform self myofascial release, soft tissue massage and other massage-type actions on his or her own body. Or, the device can be used by one person on another person.

Any of a multitude of methods of attachment may be utilized to couple the head to the handle. The preferred embodiment includes a cylindrical hole in the handle in which a cylindrical protrusion from the frame may fit. The hole features a groove around its circumference such that an o-ring around the cylindrical frame protrusion may rest within the groove, securing the coupling of the handle and head. A second non-cylindrical cavity or slot may extend beyond the cylindrical hole, in which a mating, similarly shaped non-cylindrical protrusion coupled to the end of the cylindrical frame protrusion, may rest in order to maintain the orientation of the head with respect to the head.

The element may be generally shaped as a sphere or an ellipsoid or it may be generally cylindrically shaped with round, semi-spherical ends. The element surface may be smooth or it may have grooves or bumps or any assortment of surface features. A cylinder-shaped element provides a broad, even region of massage whereas a sphere-shaped element places more force near its mid-region due to its shape. Therefore, a sphere-shaped element may be more effective for deep-tissue massage than a cylinder-shaped element, for example. The device's effectiveness may be varied by applying more or less pressure upon one of many possible shaped elements. This provides varied treatments on various parts of the human body. A variety of possible element shapes may be attached to a variety of possible frame shapes which may be coupled to the end of a handle for use on oneself or another.

The frame may extend from the handle generally aligned with the handle axis or the frame may initially be aligned with the handle axis and then bend at some angle away from the handle axis. The frame also may immediately bend away from the handle axis and then bend again back toward the handle axis. These are just a few examples of the myriad possible shapes and forms of frames which carry an axle on which an element may spin.

In another aspect, a massaging device includes a handle and a head wherein the head may exhibit a varied angular orientation relative to the handle. Embodiments may include one of the following features, or any combination thereof. The massaging device may comprise an element, an axle on which the element may spin, and an attachment ball that releasably couples to the socket opening of the handle. The attachment ball may be fully inserted within the socket opening, thereby allowing the head to spin freely around the handle axis. Another embodiment may allow the attachment ball to be partially inserted within the socket opening, thereby allowing the head to spin freely around the handle axis, while also allowing the angular orientation of the head to vary, relative to the handle axis.

### BRIEF DESCRIPTION OF THE DRAWINGS

FIG. 1 is a perspective view of a massaging device.

FIGS. 2A and 2B are front and side views, respectively, of a head, consisting of a frame and an element used in a massaging device.

FIG. 3 is a close-up view of each end of a handle of a massaging device

FIG. 4 is a close-up view of one manner of releasably coupling a head to a handle of a massaging device.

FIGS. 5A and 5B are front and side views, respectively, of a head, consisting of a frame and an element used in a massaging device.

FIG. 6 is a perspective view of a different massaging device.

FIG. 7 is a perspective view of a different massaging device.

FIG. 8 is a perspective view of a different massaging device.

FIG. 9 is a perspective view of a different massaging device.

FIG. 10 is a close-up view of an alternate manner of releasably coupling a head to a head of a massaging device.

### DETAILED DESCRIPTION

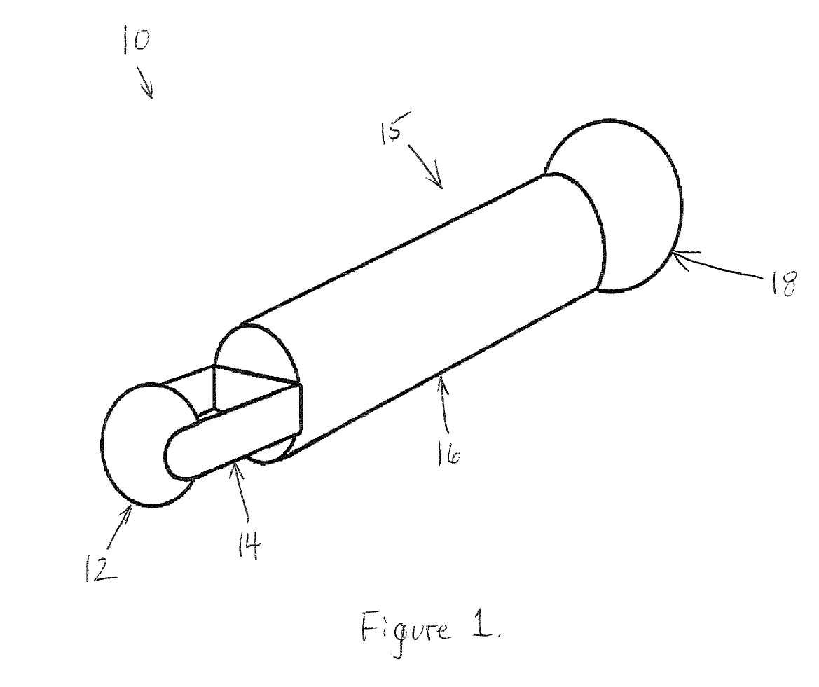

The massaging device 10 depicted in FIG. 1 comprises massaging element 12 that is carried by frame 14 such that element 12 can spin. Frame 14 is coupled to one end of handle 15. Handle 15 may consist of shaft 16 and grip 18, where grip 18 is coupled to the end of shaft 16 opposing frame 14. Massaging device 10 is particularly constructed and arranged such that a user can hold the device by the handle 15 and press the massaging element 12 against the body, at a desired position, angle and pressure, and using a desired motion. Or, the device 10 can be held only by the grip 18 or only by the shaft 16, if desired. The massaging device 10 thus allows a person to perform self myofascial release, soft tissue massage and other massage-type actions on his or her own body. Or, the device 10 can be used by one person on another person.

The device 10 can be made of materials that are able to achieve the desired results. As one non-limiting example, shaft 16 and grip 18 can be made of wood. Frame 14 is typically metal, and is coupled to spherical massaging element 12 such that element 12 can spin. Element 12 can be made from a hard smooth plastic, similar to a field hockey ball. This allows pressure to be transferred to the body through element 12, and also allows element 12 to be moved along the body surface easily and without catching and snagging any body hair and skin. Other materials and constructions are possible; for example the element 12 could have bumps and/or ridges on its surface. Regarding dimensions, they can be selected to achieve a desired result. As one non-limiting example shaft 16 can be about 18 inches long and perhaps 1-2 inches in diameter. Massaging element 12 may be larger than a golf ball but smaller than a tennis ball.

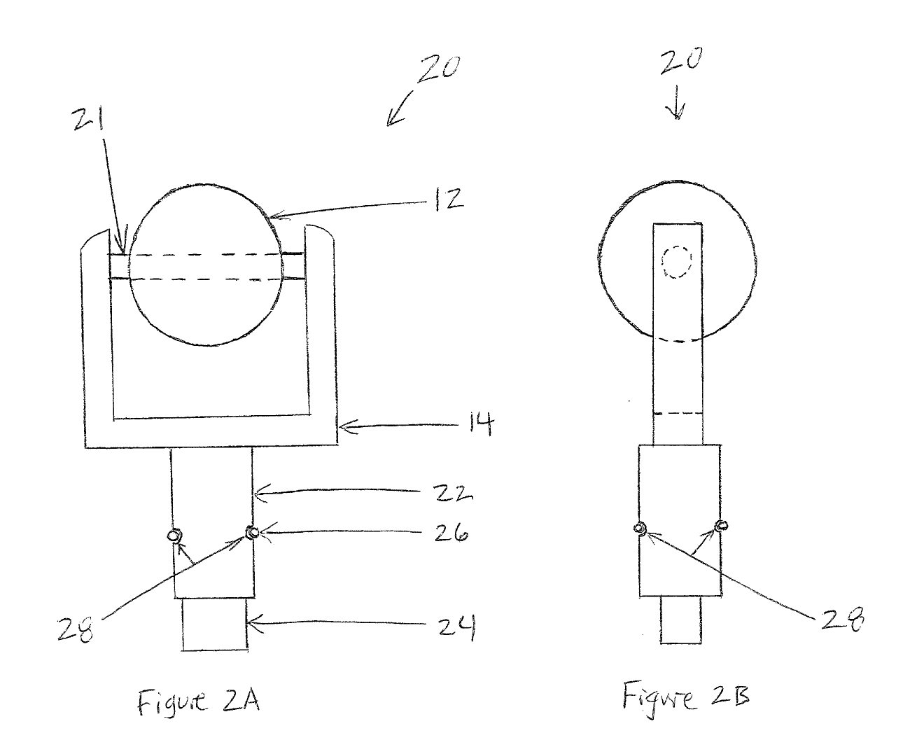

Front and side views of a releasable head 20 are shown in FIGS. 2A and 2B respectively. The head 20 consists of a frame 14, a massaging element 12 and an axle 21 on which element 12 may spin when placed in contact and moved upon the person being massaged. A cylindrical protrusion 22 and tongue 24 are shown along with an o-ring 26 resting within a cylinder groove 28.

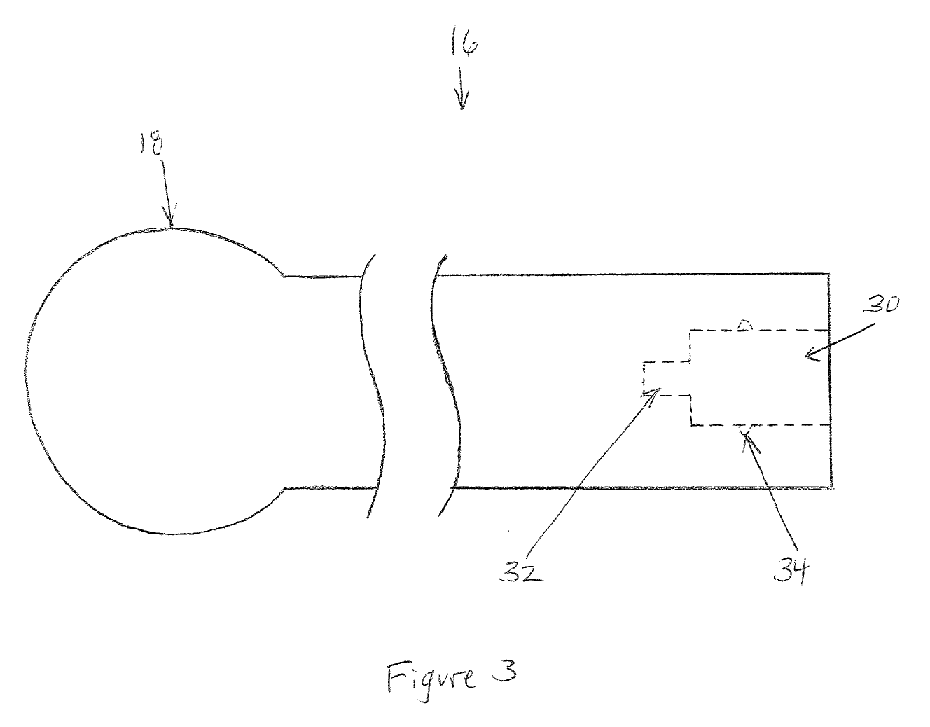

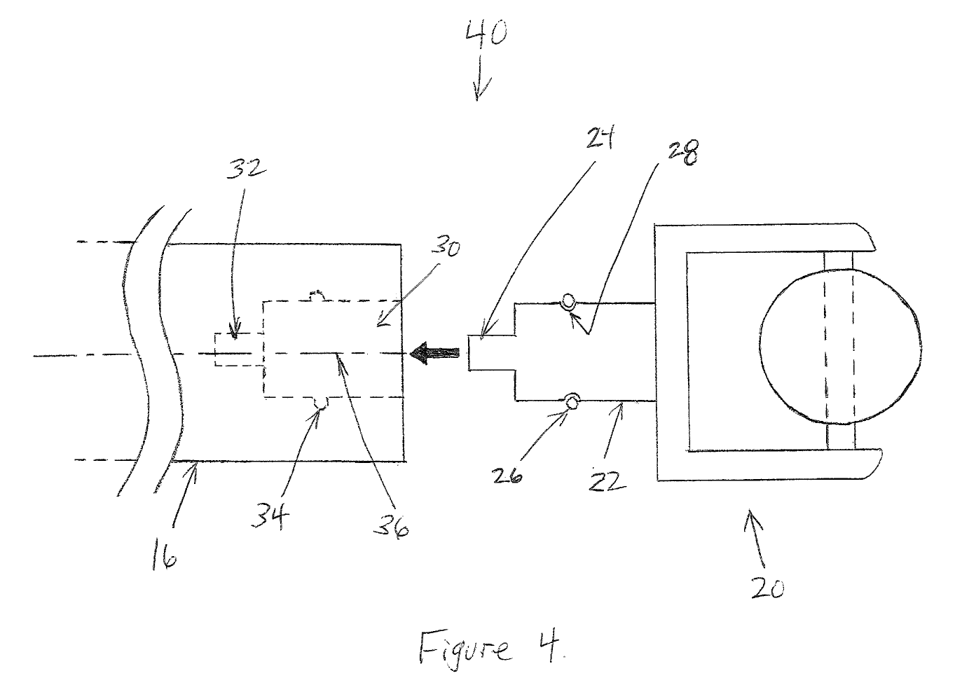

Each end of shaft 16 is shown in FIG. 3. Grip 18 is on one end and cylindrical hole 30 and slot 32 are shown opposing grip 18 on the other end of shaft 16. Around the surface of cylindrical hole 30 is hole groove 34. FIG. 4 depicts shaft/head combination 40. The end of shaft 16 has cylindrical hole 30 and alignment slot 32 in which cylindrical protrusion 22 and tongue 24 fit, respectively, when coupled together. O-ring 26 rests within cylinder groove 28 in cylindrical protrusion 22 and it aligns and secures hole groove 34 with cylinder groove 28, and therefore shaft 16 and head 20, when shaft 16 and head 20 are coupled together. The slot 32/tongue 24 coupling keeps head 20 from spinning freely upon the end of shaft 16 around handle axis 36.

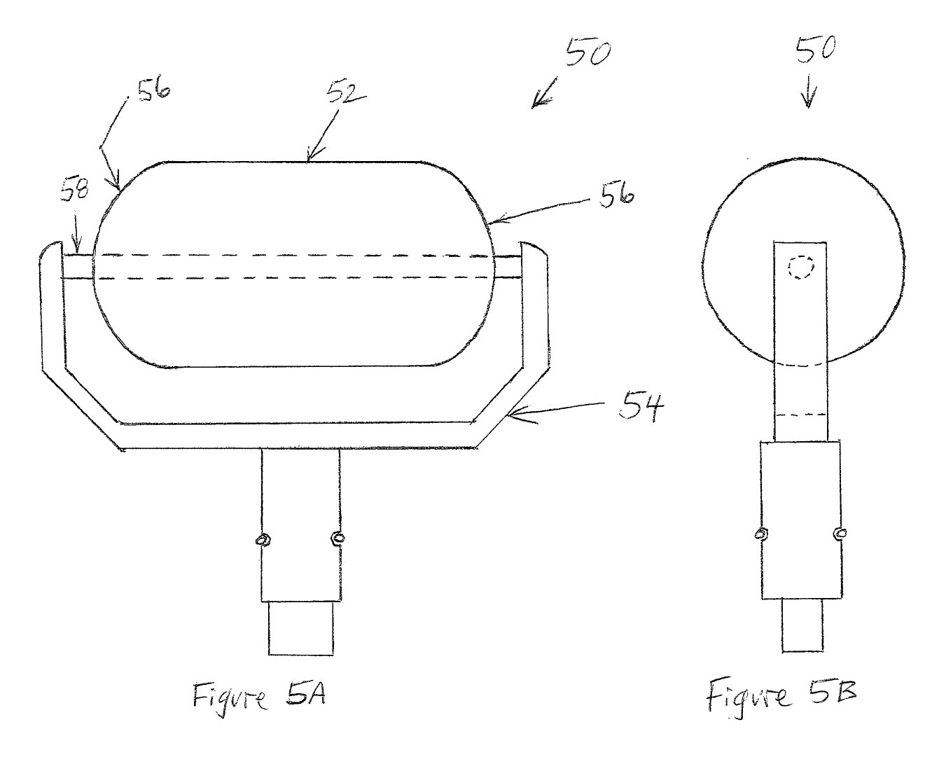

Front and side views of releasable head 50 in FIGS. 5A and 5B are different from those shown in FIGS. 2A and 2B only in the shape of the element 52 and the necessary enlargement of frame 54 and axle 58 to carry the larger element 52. This embodiment of the head 50 includes an element 52 which is generally cylindrically shaped with rounded, semi-spherical ends 56.

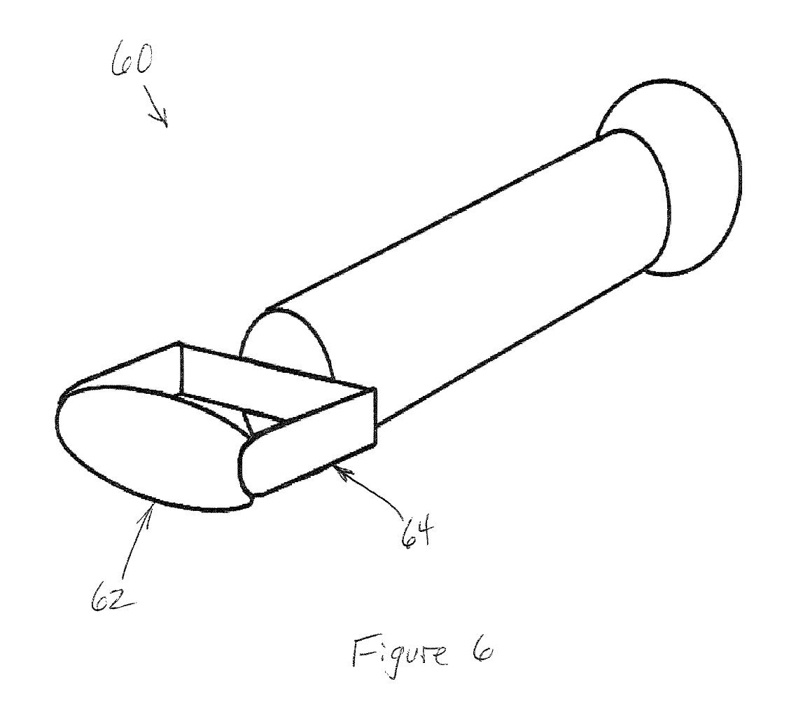

Massaging device 60, FIG. 6, differs from that of FIG. 1 only in that massaging element 62 is has a generally ellipsoid shape. Element 62 spins on frame 64 along the major axis of its ellipsoid shape. Element 62 can be any size and is preferably about 4-5 inches long.

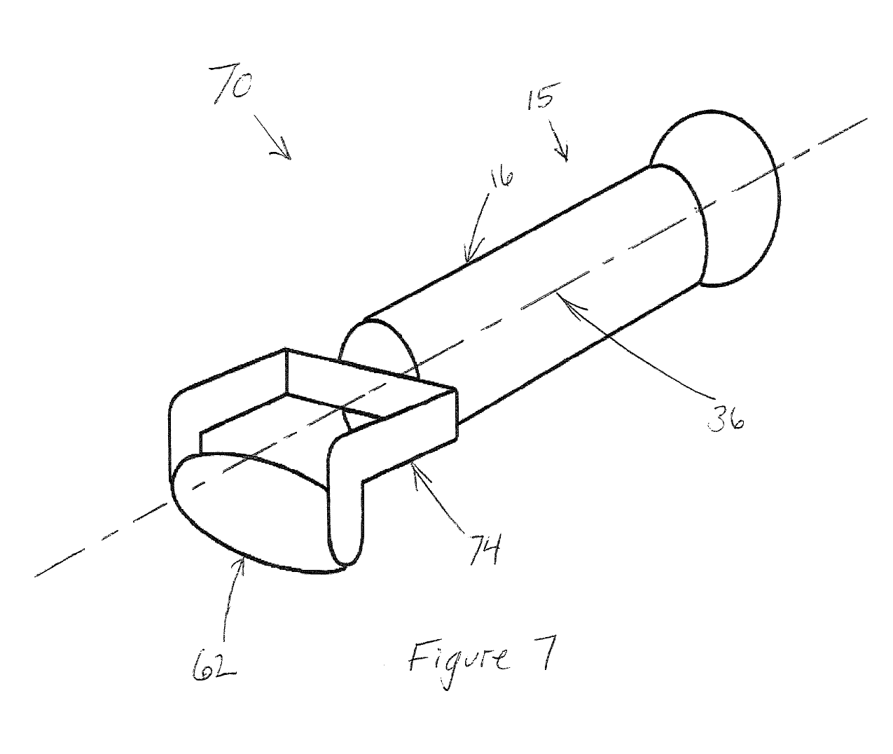

Massaging device 70, FIG. 7, differs from device 60, FIG. 6, in that not all of frame 74 extends from shaft 16 in the same general direction as handle axis 36. Frame 74 initially extends from shaft 16 in the same general direction as handle axis 36, but then bends at an angle, allowing the massaging device 70 to be used on parts of the human body requiring more space between handle 15 and the human bodily target of element 62.

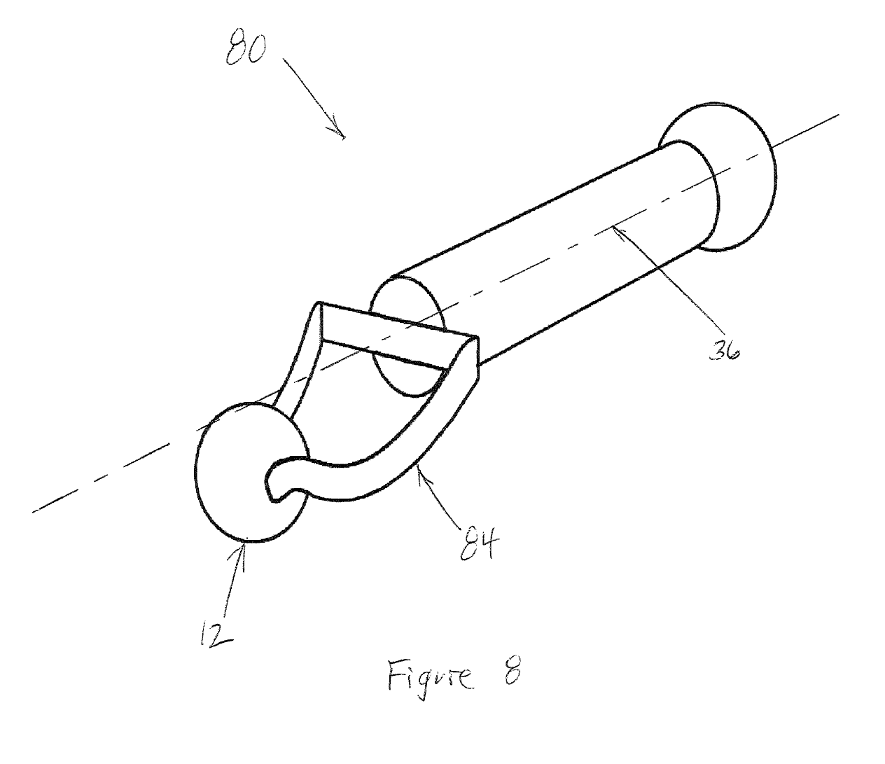

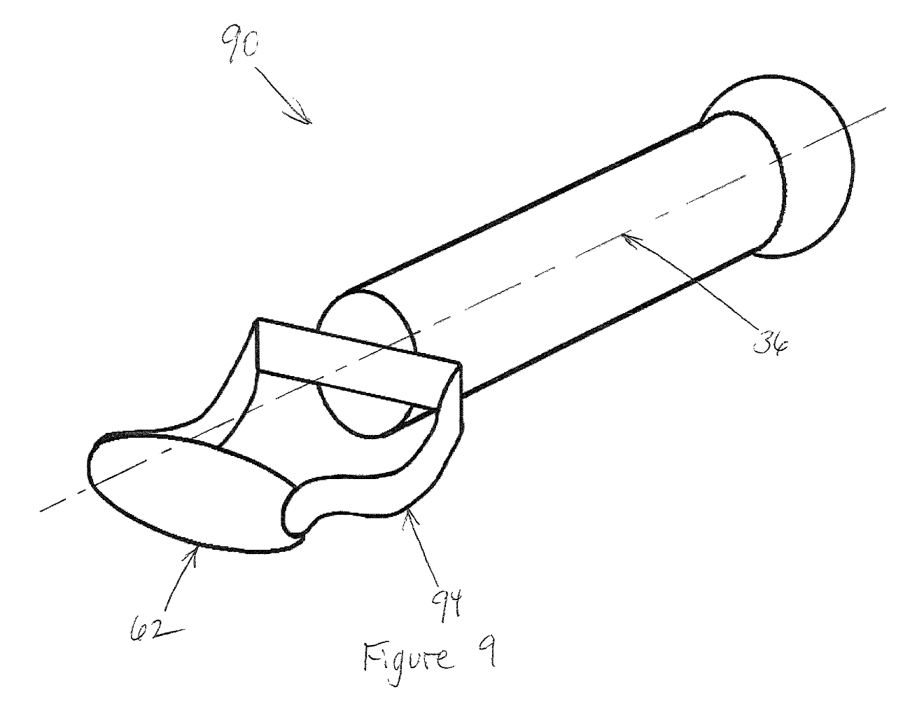

Massaging device 80, FIG. 8, differs from device 10, FIG. 1, in that frame 84 extends downward away from handle axis 36, and then bends upward again toward handle axis 36. This frame configuration allows massaging device 80 to be used on parts of the human body potentially requiring the unique pressure and clearance this configuration may offer. Massaging device 90, FIG. 9, illustrates another of myriad possible frame configurations. Frame 94 differs from device 80, FIG. 8, in that element 62 is an ellipsoid and element 12 is a sphere.

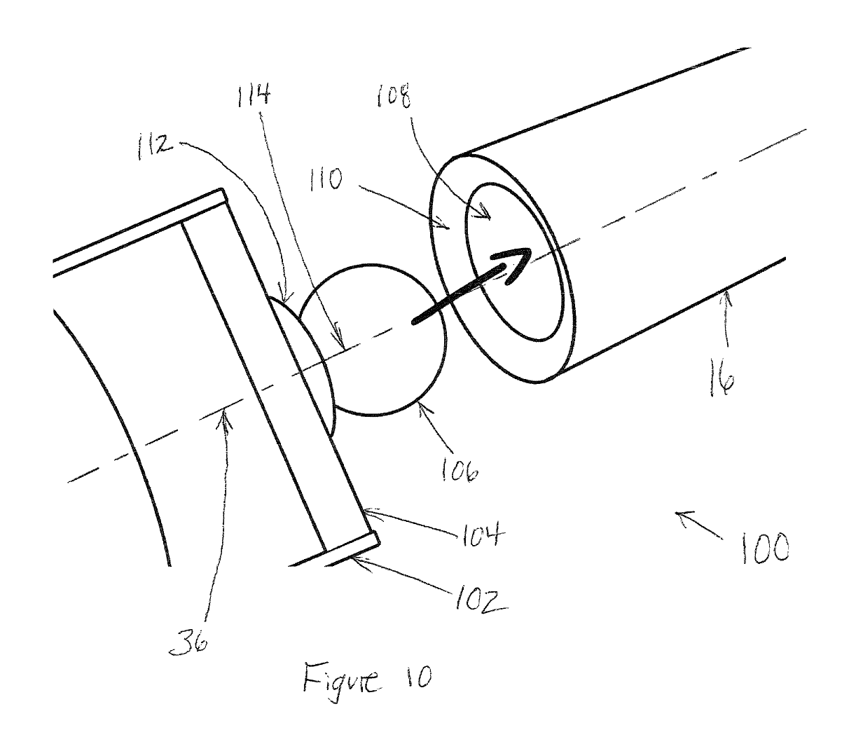

The coupling of the massage device head 20 with shaft 16, as shown in FIG. 4, illustrates the simplicity of interchanging massaging heads such as those shown in FIGS. 2A-B and 5A-B, as opposed to having a single massaging surface permanently held to a holder. Another means of accomplishing this is with the frame/shaft coupling 100 as shown in FIG. 10. Frame 102 has end cross-member 104 that carries attachment ball 106, which fits into socket opening 108 at one end of shaft 16. Angled wall 110 can facilitate proper alignment of attachment ball 106 as it is pushed into socket opening 108. Angled wall 110 also may act as a stop, against which frame guide 112 may rest when attachment ball 106 is fully inserted within the socket opening 108. The coupling 100 allows frame 102 to spin relative to handle axis 36. An alternate function of coupling 100 occurs when attachment ball 106 is not fully seated within the socket opening. This keeps frame guide 112 from fully engaging with angled wall 110, thereby functioning more like a hip joint in which varied angular orientations of frame 102 may exist, relative to handle axis 36. Attachment ball 106 may be held within the socket opening 108 in many possible ways, including a variety of ridges, o-rings, etc. within the socket opening 108. Attachment ball 106 may be removed from socket opening 108 by pulling frame 102 from shaft 16 with enough force to overcome the holding strength of the ridges, o-rings, etc which secure the attachment ball 106 within the socket opening 108.

This disclosure contemplates any other possible manner of releasably coupling the head to the handle, to make any possible head replaceable. Also, the head may or may not be rotatable around the handle axis. The subject massaging device allows a user to massage or release trigger points and body regions that are hard or impossible to reach with typical stick-type rollers. Examples include areas close to joints and along the spine. The device can be used anywhere on the body, and provides point pressure as well as rolling pressure.

A number of implementations have been described. Nevertheless, it will be understood that additional modifications may be made without departing from the scope of the inventive concepts described herein, and, accordingly, other embodiments are within the scope of the following claims.

What is claimed is:

1. A massaging device, comprising:
a handle with a first and a second end and a handle axis;
a head comprising a frame, an element, and an axle;
wherein the frame carries the axle on which the element may spin; and
wherein the head is releasably coupled to the handle.

2. The massaging device of claim 1 wherein the handle is comprised of a shaft and a grip on the first end of the handle.

3. The massaging device of claim 2 wherein the grip is a generally circular knob.

4. The massaging device of claim 1 that is constructed and arranged such that a user can hold the device by the handle and press the massaging element against a surface, at a desired position, angle and pressure, and using a desired motion.

5. The massaging device of claim 1 wherein the device allows a person to perform self-myofascial release, self-tissue massage and other types of self-massage.

6. The massaging device of claim 1 wherein the second end of the handle comprises a cylindrical hole and a non-circular slot abutting and extending beyond the cylindrical hole.

7. The massaging device of claim 5 wherein the head comprises a mating cylindrical protrusion and a mating non-circular tongue abutting and extending beyond the cylindrical protrusion.

8. The massaging device of claim 1 wherein the element is generally shaped as a sphere.

9. The massaging device of claim 1 wherein the element is generally shaped as an ellipsoid.

10. The massaging device of claim 1 wherein the element is generally cylindrically shaped with round, semi-spherical ends.

11. The massaging device of claim 1 wherein the frame extends from the handle and is generally aligned with the handle axis.

12. The massaging device of claim 8 where the frame also bends away from the handle axis.

13. The massaging device of claim 1 where the frame bends away from the handle axis and then bends back toward the handle axis.

14. A massaging device, comprising:
a handle with two ends, a handle axis, a socket opening and an angled wall;
a head comprising a frame, an element, an axle, an attachment ball, and a frame guide;
wherein the frame carries the axle on which the element may spin;
wherein the socket hole is on one end of the handle and the angled wall surrounds the socket hole;
wherein the head is releasably coupled to the handle by inserting the attachment ball into the socket hole until the frame guide comes in contact with the angled wall; and
wherein the head rotates around the handle axis.

15. The massaging device of claim 14 wherein the frame guide is only partially in contact with the angled wall allowing the head to rotate around the handle axis and to be angled away from the handle axis.

16. A massaging device, comprising:
a handle comprising:
two ends;
a handle axis;
a grip on one end; and
a cylindrical hole and a non-circular slot abutting and extending beyond the cylindrical hole; and
a head comprising:
a frame that is generally aligned with the handle axis and releasably coupled to one end of the handle;
a cylindrical protrusion and a non-circular tongue abutting and extending beyond the cylindrical protrusion, both constructed and arranged to mate with the cylindrical hole and the non-cylindrical slot, respectively;
a generally spherical element; and
an axle;
wherein the frame carries the axle on which the element may spin.

17. The massaging device of claim 16 wherein the element is cylindrically shaped with rounded, semi-spherical ends.
